(19) United States
(12) Patent Application Publication
(10) Pub. No.: US 2021/0042813 A1
(43) Pub. Date: Feb. 11, 2021

(54) METHOD, APPARATUS AND SYSTEM FOR GENERATING PREFERENTIAL INFORMATION ACCORDING TO RECIPE TASK

(71) Applicant: BOE TECHNOLOGY GROUP CO., LTD., Beijing (CN)

(72) Inventors: Qingguo YANG, Beijing (CN); Honglei ZHANG, Beijing (CN)

(21) Appl. No.: 16/966,864

(22) PCT Filed: Sep. 11, 2019
(86) PCT No.: PCT/CN2019/105408

§ 371 Date: Jul. 31, 2020

(30) Foreign Application Priority Data
Sep. 29, 2018 (CN) 201811148419.6

(51) Int. Cl. G06Q 30/06; G06Q 10/08; G06Q 30/00; G06Q 30/02; G06F 16/9535

(52) U.S. Cl. CPC G06Q 30/0631; G06Q 10/0875; G06Q 30/0185; G06K 7/1095; G06Q 30/0201; G06Q 30/0643; G06F 16/9535; G06Q 30/0236

(57) ABSTRACT

The present disclosure provides a method, a computing apparatus, portable electronic device and a system for generating preferential information according to a recipe task. The method includes a recipe task generation step of generating a recipe task associated with at least one commodity; a task acquisition step of acquiring a selection of the recipe task from a customer; a commodity information receiving step of receiving from the customer commodity information of a commodity found by the customer according to the recipe task; a task determination step of comparing the received commodity information with the at least one commodity, and determining that the recipe task is finished in response to the received commodity information matches the at least one commodity; and a preferential information generation step of generating preferential information after it is determined that the recipe task is finished.

### CROSS-REFERENCE TO RELATED APPLICATIONS

The present application claims the priority of Chinese Patent Application No.

201811148419.6 filed with the SIPO on Sep. 29, 2018, the entire contents of which are incorporated herein by reference.

### TECHNICAL FIELD

The present disclosure relates to the field of information processing, and in particular, to a method, a computing apparatus, a portable electronic device, and a system for generating preferential information according to a recipe task.

### BACKGROUND

At present, price-off promotion has become a common method for business in a store or supermarket to destock or promote new products. However, the related promotion methods are relatively simple, only limited to price off, rebate and coupons, and there is little correlation among various promotional commodities, therefore the customers show little enthusiasm for promotional activities, which results in poor promotion effects. Moreover, those promotion methods involve little interaction with the customers and therefore fail to bring good customer experience to the customers.

### SUMMARY

According to one aspect of the present disclosure, a method for generating preferential information according to a recipe task is provided, and includes: a recipe task generation step of generating a recipe task associated with at least one commodity; a task acquisition step of acquiring a selection of the recipe task from a customer; a commodity information receiving step of receiving from the customer commodity information of a commodity found by the customer according to the recipe task; a task determination step of comparing the received commodity information with the at least one commodity, and determining that the recipe task is finished in response to the received commodity information matches the at least one commodity; and a preferential information generation step of generating preferential information associated with the at least one commodity after it is determined that the recipe task is finished.

In one embodiment, the at least one commodity is a promotional commodity, which includes at least one of an unsalable commodity, a commodity with a short shelf life and a promoted commodity.

In one embodiment, the at least one commodity further includes a relevant commodity that is associated with the promotional commodity and includes at least one of an ingredient, a seasoning, and a tool for preparing a dish in the recipe task.

In one embodiment, the commodity information includes at least one of a picture and a barcode of a commodity.

In one embodiment, the preferential information includes at least one of an electronic coupon and a physical coupon.

In one embodiment, a preferential degree of the preferential information is inversely proportional to time spent by the customer in completing the recipe task.

In one embodiment, a cooking video of the dish in the recipe task is pushed to the customer.

In one embodiment, the recipe task generation step includes: generating a plurality of candidate recipe tasks according to a promotion priority of the promotional commodity, a number of the promotional commodity or a production date of the promotional commodity.

In one embodiment, the task acquisition step includes: acquiring a selection, from the customer, of a recipe task for at least one of the plurality of candidate recipes.

In one embodiment, the method further includes a step of acquiring customer information before the recipe task generation step, and the recipe task generation step includes generating the recipe task based on the customer information.

In one embodiment, the step of acquiring the customer information includes:

receiving ID information from the customer; matching the ID information of the customer with membership ID information in a membership database to determine whether the customer is a member; serving membership information of the customer as the customer information when it is determined that the customer is a member; otherwise, determining the non-member customer as a new member, and acquiring the membership information input by the new member, and serving the acquired membership information as the customer information.

In one embodiment, between the task acquisition step and the commodity information receiving step, the method further includes the following step: determining whether a QUIT command input by the customer is received or whether the recipe task times out; and performing the preferential information generation step when the QUIT command is received or the recipe task times out.

In one embodiment, the recipe task generation step further includes: retrieving information associated with the promotional commodity from a database through big data analysis.

According to another aspect of the present disclosure, a computing apparatus for generating preferential information according to a recipe task is provided, and includes: a recipe task generating device configured to generate a recipe task associated with at least one commodity; a task acquiring device configured to acquire a selection of the recipe task from a customer; a commodity information receiving device configured to receive from the customer commodity information of a commodity found by the customer according to the recipe task; a task determination device configured to compare the received commodity information with the at least one commodity, and determine that the recipe task is finished in response to the received commodity information matches the at least one commodity; and a preferential information generating device configured to generate preferential information associated with the at least one commodity after it is determined that the recipe task is finished.

According to another aspect of the present disclosure, the computing apparatus further includes a customer information acquiring device configured to acquire customer information; and the recipe task generating device is further configured to generate the recipe task according to the customer information.

According to another aspect of the present disclosure, a computer storage medium having a computer program stored thereon is provided. When the computer program is executed on a processor, the following steps are performed: generating a recipe task associated with at least one commodity; acquiring a selection of the recipe task from a customer; receiving from the customer commodity information of a commodity found by the customer according to the recipe task; comparing the received commodity information with the at least one commodity, and determining that the recipe task is finished in response to the received commodity information matches the at least one commodity; and generating preferential information associated with the at least one commodity after it is determined that the recipe task is finished.

According to another aspect of the present disclosure, a portable electronic device configured to communicate with a computing apparatus for generating preferential information according to a recipe task is provided, and includes: a first receiving device configured to receive a recipe task associated with at least one commodity from the computing apparatus; a display device configured to display the recipe task; an identification device configured to identify a selection of the recipe task from a customer; an acquisition device configured to acquire commodity information of a commodity found by the customer according to the recipe task; a transmitting device configured to transmit the identified selection and the acquired commodity information to the computing apparatus; and a second receiving device configured to receive a determination result concerning whether the recipe task is finished and the preferential information associated with the at least one commodity from the computing apparatus.

According to another aspect of the present disclosure, a system for generating preferential information is provided, and includes a computing apparatus for generating preferential information according to a recipe task, and a portable electronic device. The computing apparatus includes a recipe task generating device configured to generate a recipe task associated with at least one commodity, a task acquiring device configured to acquire a selection of the recipe task from a customer, a commodity information receiving device configured to receive from the customer commodity information of a commodity found by the customer according to the recipe task, a task determination device configured to compare the received commodity information with the at least one commodity, and determine that the recipe task is finished in response to the received commodity information matches the at least one commodity, and a preferential information generating device configured to generate preferential information associated with the at least one commodity after it is determined that the recipe task is finished. The portable electronic device includes: a first receiving device configured to receive the recipe task from the computing apparatus, a display device configured to display the recipe task, an identification device configured to identify the selection of the recipe task from the customer, an acquisition device configured to acquire the commodity information of the commodity found by the customer according to the recipe task, a transmitting device configured to transmit the identified selection and the acquired commodity information to the computing apparatus, and a second receiving device configured to receive a determination result of the recipe task and the preferential information from the computing apparatus.

According to another aspect of the present disclosure, a system for generating preferential information is provided, and includes: a recipe task generating device configured to generate a recipe task associated with at least one commodity, a display device configured to display the recipe task, an identification device configured to identify a selection of the recipe task from a customer, an acquisition device configured to acquire commodity information of a commodity found by the customer according to the recipe task, a task determination device configured to compare the received commodity information with the at least one commodity, and determine that the recipe task is finished in response to the received commodity information matches the at least one commodity, and a preferential information generating device configured to generate preferential information associated with the at least commodity after it is determined that the recipe task is finished.

### BRIEF DESCRIPTION OF THE DRAWINGS

The accompanying drawings are intended to provide a further understanding of the present disclosure, and are incorporated in and constitute a part of the specification. The drawings, together with the specific embodiments below, are intended to explain the present disclosure, but do not constitute a limitation to the present disclosure. In the drawings:

FIG. 1 is a flowchart illustrating a method for generating preferential information according to a recipe task according to the embodiments of the present disclosure;

FIG. 2 is a flowchart illustrating a method for generating preferential information according to a recipe task according to the embodiments of the present disclosure;

FIG. 3 is a flowchart illustrating a method for generating preferential information according to a recipe task according to the embodiments of the present disclosure;

FIG. 4 is a flowchart illustrating a method for generating preferential information according to a recipe task according to the embodiments of the present disclosure;

FIG. 5 is a block diagram of a computing apparatus for generating preferential information according to a recipe task according to the embodiments of the present disclosure; and

FIG. 6 is a block diagram of portable electronic device according to the embodiments of the present disclosure.

### DETAILED DESCRIPTION

The specific embodiments of the present disclosure are descripted in detail below with reference to the accompanying drawings. It should be understood that the specific embodiments described herein are merely for illustrating and explaining the present disclosure, but are not intended to limit the present disclosure.

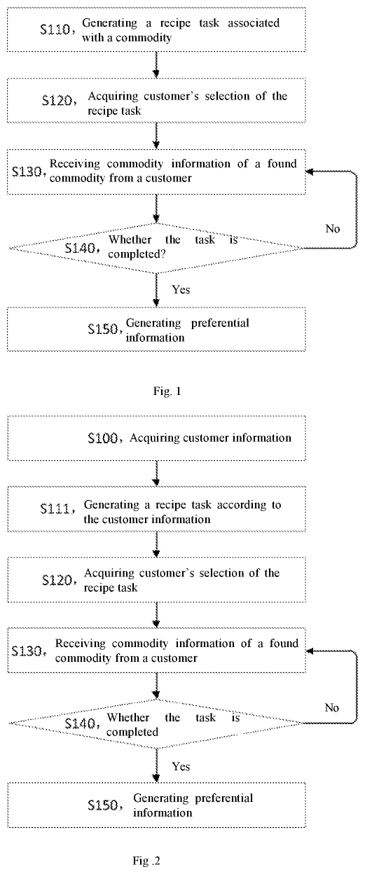

FIG. 1 is a flowchart exemplarily illustrating a method for generating preferential information according to a recipe task according to the embodiments of the present disclosure. A preferential information generating apparatus may be provided in a store or supermarket to perform the method for generating preferential information according to a recipe task shown in FIG. 1. As shown in FIG. 1, the method for generating preferential information according to a recipe task includes steps S110 to S150 performed by the preferential information generating apparatus.

At recipe task generation step S110, a recipe task associated with at least one commodity is generated.

The at least one commodity may include a promotional commodity, and the promotional commodity may include at least one of a promoted commodity, a commodity with a short shelf life, an overstocked commodity, and an unsalable commodity. The promoted commodities include especially new products, which may become well known with the aid of the promotion; the commodities with a short shelf life include especially various foods such as dried and fresh fruits, fresh vegetables and delicatessens, the sales of which may increase with the aid of the promotion, so as to reduce losses caused by expired commodities; and the overstocked or unsalable commodities refer to the commodities whose inventory exceeds the normal turnover reserve due to various reasons, and the overstocked products and the logistics (warehousing) cost can be reduced with the aid of the promotion. In some embodiments, the promotional commodity may be a main ingredient in a recipe for preparing a dish. Alternatively or additionally, the promotional commodity may also be a supplementary ingredient or seasoning in the recipe, such as vegetables, meat, fruits, soy sauce, thirteen-spices powder, and Pixian bean paste.

In some embodiments, a plurality of candidate recipes may be retrieved from a recipe database according to commodity information, especially promotional commodity information, in a commodity database of a store, and a recipe task associated with at least one of the plurality of candidate recipes may be generated. It is possible to generate a recipe task for each candidate recipe. Alternatively, the plurality of candidate recipes may be generated according to different criteria, such as a promotion priority of the promotional commodity, the number of the promotional commodity, and a production date of the promotional commodity, and then a recipe task associated with one or more of the plurality of candidate recipes may be selected. In one example, a candidate recipe may include several promotional commodities when there are a plurality of promotional commodities. In such example, Candidate Recipe 1 may be generated based on the number of the promotional commodities included in Candidate Recipe 1. In another example, information about promotional commodity may include date-related information about a promotional commodity, such as the production date or shelf life. In such example, Candidate Recipe 2 may be generated according to the date-related information about the promotional commodities included in Candidate Recipe 2. For example, a recipe that includes a promotional commodity having a shorter shelf life or shorter remaining shelf life may be selected as a candidate recipe. In yet another example, promotional priority may be assigned to a promotional commodity by the store according to the marketing strategies thereof. In such example, Candidate Recipe 3 may be generated based on the promotional priority of each promotional commodity. For example, a recipe that includes a promotional commodity having a higher promotional priority may be selected as a candidate recipe. In this way, the promotional commodity information may be incorporated into a single recipe task more effectively in a manner desired by the store, and the workload of integrating relevant information when the store provides the relevant information to customers may also be greatly reduced. In some embodiments, the recipe task may be generated according to sales information of the commodities.

The recipe task may include all or some of the promotional commodities that are included in a corresponding recipe and are to be found in the store. Additionally, the recipe task may also include a relevant commodity associated with the recipe. The relevant commodity may refer to a commodity, except for the promotional commodity, associated with the corresponding recipe. For example, when the promotional commodity is a main ingredient in the recipe for preparing a dish, the relevant commodity may include supplementary ingredients or seasonings in the recipe, which include, but are not limited to, vegetables, fruits, soy sauce, thirteen-spices powder, and Pixian bean paste. More particularly, the relevant commodity may further include tools for preparing the dish, such as a kitchen knife, a cutting board, a wok, a spatula, a spoon, an oven, and a refrigerator (e.g., some food needs to be frozen while being cooked). In some embodiments, the information about the relevant commodities may be stored in advance in the recipe database together with the corresponding recipe, and may be retrieved from the recipe database together with the corresponding recipe for generating the recipe task.

In some embodiments, the relevant commodity may be a commodity that is not associated with the corresponding recipe, but is associated with at least one promotional commodity in the recipe according to predetermined sales strategies. For example, the relevant commodity may be a high-profit commodity matched with a low-profit promotional commodity, or an unsalable commodity matched with a new promotional commodity, or a high-profit commodity matched with a high-profit promotional commodity. In this case, the candidate recipe may be retrieved from the recipe database based on both the promotional commodity and the preset relevant commodity.

By associating the promotional commodity with a plurality of relevant commodities with a recipe task, more commodity information may be effectively incorporated into a single recipe task, thereby improving the efficiency of providing commodity information for the customers.

The recipe task may be sent to the customer via a communication device, for example, WIFI or Bluetooth. A specific QR code for the recipe task may be directly generated without using a communication device, and the recipe task may be obtained according to the QR code after the customer scans the QR code with a client terminal, or a web link to the recipe task is generated according to the QR code after the customer scans the QR code with the client terminal and the customer may obtain the recipe task by accessing the web link.

At task acquisition step S120, a selection of the recipe task is acquired from a customer.

For example, the generated recipe tasks may be displayed to the customer through a customer interface on a display device, so as to allow the customer to select. The recipe tasks may be displayed in a random order. In some embodiments, the recipe tasks may be arranged in the order in which the candidate recipes corresponding to the recipe tasks are selected. For example, the recipe task corresponding to the firstly selected candidate recipe is displayed most prominently, such as being displayed in the center of a screen of the display device, or being displayed with the largest icon. The customer's selection may be received through the customer interface. For example, the customer may select a recipe task by clicking on an icon of the recipe task in the customer interface. Alternatively, the customer may select a recipe task by entering a code of the recipe task with a keyboard.

In some embodiments, the recipe task may be sent to the client terminal (e.g. a mobile phone) of the customer via a communication device, for example, WIFI or Bluetooth. A specific QR code for the task may be directly generated without using the communication device. The recipe task may be obtained according to the QR code after the customer scans the QR code with the client terminal, or a web link to the recipe task is generated according to the QR code after the customer scans the QR code with the client terminal and the customer may obtain the recipe task by accessing the web link. Thus, the customer can select a recipe task with the communication device and send his/her selection to the preferential information generating apparatus in the store via the communication device, so that the preferential information generating apparatus may acquire the customer's selection.

At commodity information receiving step S130, commodity information of the commodity found by the customer according to the recipe task is received from the customer.

After the recipe task is obtained, the customer starts to carry out the recipe task, that is, looking for corresponding promotional commodities in the supermarket or store according to the selected recipe task. When the customer believes that he has found the corresponding promotional commodities, the customer sends the commodity information about the found commodities (that is, a result of executing the recipe task) to the preferential information generating apparatus for determining. For example, after the customer has found a commodity, the customer may take a picture, or scan a QR code on an electronic tag of the commodity or a barcode on the commodity with his/her own portable electronic device (such as a mobile phone or a tablet computer), and upload the acquired picture, the QR code or the barcode to the preferential information generating apparatus through a wired or wireless network. Therefore, the commodity information about the commodity found by the customer according to the recipe task may include information related to the promotional commodity included in the recipe task, such as the picture, the barcode and the QR code of the promotional commodity, and other information that can uniquely identify the promotional commodity. Additionally, considering that the customer may exit the promotional activity or suspend the recipe task due to an accident that occurs while carrying out the recipe task, such as being accidental injury and an emergency, the customer may input a control command, such as a command of quitting the recipe task, suspending the recipe task, or continuing the recipe task. In such case, the customer may request for ending the task ahead of time, suspending the task, or continuing the task by uploading the related control command to the preferential information generating apparatus through the portable electronic device. Alternatively, instead of sending the commodity information of the found commodity or the control command to the preferential information generating apparatus through the portable electronic device such as a mobile phone, the customer may manually input the above information/command into the preferential information generating apparatus through a customer input device (e.g. a keyboard, a mouse, and a touch screen).

At task determination step S140, the received commodity information is compared with the at least one commodity, and it is determined that the recipe task is finished in response to the received commodity information matches the at least one commodity.

For example, after the comparison, the step S130 is then performed if it is determined that the recipe task is not completed, and the step S150 is then performed if it is determined that the recipe task is completed. In some embodiments, when the received commodity information match the commodities in the recipe task, it may be determined that the customer has found all promotional commodities, and may be accordingly determined that the recipe task is completed. Otherwise, the preferential information generating apparatus continues to wait for the commodity information of the commodity found according to the recipe task from the customer. For example, after receiving the commodity information, the preferential information generating apparatus identifies the relevant information (including a pictures, a QR code or a barcode), provided by the customer, about the commodity found by the customer through a corresponding identification program (such as an image identification program or a QR code and barcode identification program), so as to determine whether the commodity fully matches the promotional commodity to be found in the recipe task; if so, it is determined that the task is completed; otherwise, it is determined that the task is not completed. Additionally, as described above, it is determined that the recipe task ends when the control command to exit the recipe task is received. Additionally or alternatively, a task timer starts upon acquiring the selection of the recipe task from the customer, and it is determined that the recipe task ends when the task timer expires.

At preferential information generation step S150, preferential information is generated after it is determined that the recipe task is finished.

In some embodiments, according to the customer's completion of the recipe task, electronic reward vouchers such as electronic coupons and payment identification codes for the promotional commodities and the optional relevant commodities that are associated with the recipe task may be generated. The payment identification codes and the electronic coupons may be bound with a customer ID or a membership card, so that the customer may pay directly with the payment identification codes and the coupons when paying in an automatic way or other ways. The electronic reward vouchers may make it easy and convenient for the customers to perform electronic payment. However, considering that some customers (e.g., middle aged and elderly people) may be not used to electronic payment or cannot pay electronically, paper reward vouchers such as paper coupons and parking coupons for the promotional commodities and the optional relevant commodities that are associated with the recipe task may be generated and printed according to the customer's completion of the recipe task.

In some embodiments, the preferential degree may be inversely proportional to the time spent by the customer in completing the recipe task, when the customer completes the recipe task. In this way, the customers may be motivated to complete the tasks as quickly as possible, thereby improving promotion efficiency; moreover, an atmosphere of contest or competition is created to stimulate the actuation and fighting spirit of customers, so that more people may pay attention to and participate in the promotion activities. Specifically, the ranking may be determined according to the time spent in completing the task, and different discounts are provided according to the ranking. Larger discounts should be given especially for the customers who win the top three, and trophies and large models of discount cards should be awarded on site, so as to produce maximum promotion effects. For the customers who have not completed the tasks (within a specified time), participation award or memorial award, such as coupons with lower discounts, may be given as encouragement.

In the above method for generating preferential information according to a recipe task according to some embodiments of the present disclosure, the information about the promotional commodities is automatically organized and presented to the customers in a more customer-friendly manner through the introduction of the recipe tasks. In this way, the customers may receive the promotion information in an interactive way, which improves the experience and acceptance of the customers for receiving the promotion information. Further, big data analysis may be used to generate the recipe tasks, that is, relevant data may be retrieved and processed according to a promotional commodity information database (for storing information about the promotional commodities) and a recipe database (for storing and retrieving recipes) which are stored in advance in a computer system of a store or supermarket, so that the targeted promotion information can be provided to the customers, thereby greatly reducing the burden on the manufacturers in collecting, collating and organizing information when providing the commodity information to the customers.

In some embodiments, a man-machine interaction process in the method for generating preferential information according to a recipe task according to the present disclosure may be performed as follows: after a promotional activity begins, a customer may obtain and select a recommended recipe task via a communication interface of a preferential information generating apparatus in a supermarket, and the recipe task may include finding ingredients (i.e., promotional commodities) required for preparing the dish in the recipe; the customer then looks for the ingredients required for preparing the dish in the recipe in the supermarket, and inputs or sends the information (such as a barcode or picture) about the found ingredients to the preferential information generating apparatus via the communication interface; the preferential information generating apparatus determines whether the task is completed or the task is ended according to the information input by the customer; if it is determined that the task is completed or ended, the preferential information generating apparatus generates preferential information and outputs or sends the preferential information to the customer via the communication interface, otherwise, the preferential information generating apparatus prompts the customer to continue to carry out the recipe task until the remaining promotional commodities have been found by the customer, the customer quits the task voluntarily, or the task times out.

In some embodiments, the preferential information generation step S150 may further include generating a cooking video for the corresponding recipe of the completed recipe task. The video may be a video link or a video file. The video link and/or the video file are/is pushed to the customer ID or the mobile terminal of the customer after the customer completes the recipe task.

FIG. 2 is a flowchart exemplarily illustrating a method for generating preferential information according to a recipe task according to the embodiments of the present disclosure, the method including steps S100-S150. Except for steps S100 and S111, the steps S120 to S140 in FIG. 2 are the same as those in FIG. 1, so the steps S120 to S140 are not repeated here.

As shown in FIG. 2, before the recipe task generation step S110, the method further includes the step S100: acquiring customer information. The customer information may be acquired according to customer ID information from a membership database. The customer information may include personal information, preference, or purchase history of a customer. The customer ID information may be information that is collected in real time, such as a collected image of the customer, or collected biometric data of the customer, such as fingerprints. Alternatively or additionally, the customer ID information may also be the data that is input by the customer via an input interface, such as a customer ID and a membership card number.

As shown in FIG. 2, the recipe task generation step S110 includes step S111 of generating the recipe tasks, such as a plurality of candidate recipe tasks, based on the customer information. In some embodiments, the recipe tasks may be generated based on one or more of the customer information. For example, the recipe tasks may be generated based on the purchase history of a customer. In one example, if the purchase history of a customer indicates that he/she often buys meat products, the recipe tasks associated with promotional meat commodities, such as “please find ingredients for preparing Dongpo Pig Knuckle/Braised Spare Ribs with Brown Sauce”, may be recommended to him/her. Additionally or alternatively, the recipe tasks may be generated based on the personal information of a customer. For example, the recipe tasks including pork may not be recommended to a customer if he/she has registered as “the Hui nationality”. Additionally or alternatively, the recipe tasks may be generated based on the food preference of a customer. In one example, the recipe tasks including meat may not be recommended to a customer if he/she has registered as a vegetarian.

In the method for generating preferential information according to the recipe task shown in FIG. 2, by taking the customer information (such as membership information of supermarket, shopping habits of customers and food preference derived therefrom) into account during the generation of the recipe tasks, personalized requirements of the customers are fully considered when providing the promotion information for the customers, which leads to a higher matching degree of the recipe task to be carried out by a customer and his/her actual needs, thereby further improving the experience of the customer for receiving the promotion information.

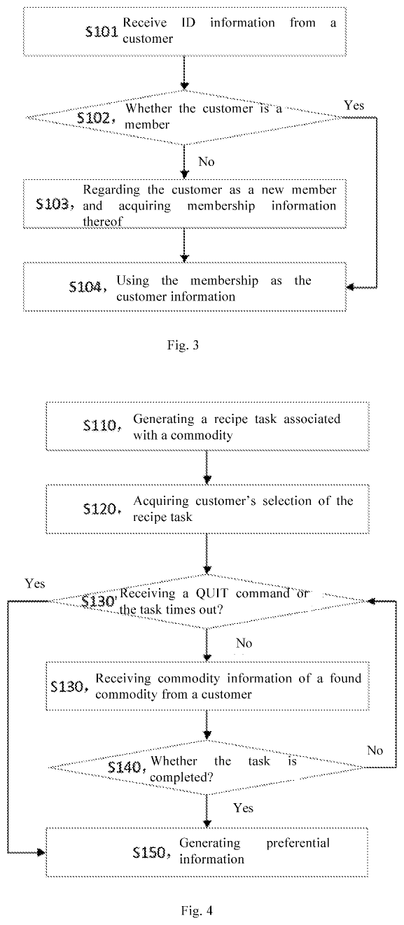

FIG. 3 is a flowchart of acquiring customer information in the embodiments of a method for generating preferential information according to a recipe task of the present disclosure. As shown in FIG. 3, the step of acquiring customer information includes steps S101 to S104.

At step S101, ID information is received from a customer. In some embodiments, the step S101 may include taking a picture of a customer's face with a camera.

At step S102, the ID information of the customer is matched with membership ID information in a membership database to determine whether the customer is a member. In the step S102, information matching may be performed by means of face recognition.

At step S103, membership information is served as the customer information in response to it is determined that the customer is a member. The membership information in the membership database may be the information that was entered when a customer was registered as a member, or may be the information obtained by recording and analyzing the data (e.g. sales data) related to the customer. The membership information may include personal information of the customer, such as birthday, age, gender and nationality. The membership information may further include preference information of the customer, for example, which cuisine (e.g. Sichuan Cuisine, Shandong Cuisine, Cantonese Cuisine, and Huai-Yang Cuisine) the customer likes, whether a customer is a vegetarian, and whether a customer has dietary restrictions. The preference of the customer may be manually input by the customer, or may be estimated or inferred from the personal information and the purchase history of the customer. For example, the preference of a customer may be inferred based on the age, gender, occupation, categories and brands of purchased commodities, and purchase frequency of the customer. The membership information may further include purchase history of the customer, and the purchase history may include, for example, the commodities that the customer has recently purchased or the commodities that the customer periodically purchases.

At step S104, in response to it is determined that the customer is not a member, the non-member customer is determined as a new member. The non-member customer may be instructed to manually enter customer information. Additionally or alternatively, the non-member customer may be prompted to register as a member, and the membership information input when he/she registers as a member is acquired and used as the customer information.

It should be understood that a recipe task may terminate in two conditions: (1) under a normal condition, that is, when the task is completed, the task may terminate; (2) under a special condition, that is, when the task is not completed, the task may terminate compulsorily.

FIG. 4 is a flowchart illustrating a method for generating preferential information according to a recipe task according to the embodiments of the present disclosure.

As shown in FIG. 4, in the special case where a customer exits the promotional activity or suspends the recipe task, before the step S130 of receiving the commodity information of the commodity found by the customer, the method further includes the following steps S110 to S150.

At step S130′, a fact that whether a control command input by the customer is received or whether the task times out is determined, for example, a fact whether a command to request “exiting the task” is received from the customer or whether the recipe task times out is determined. If the QUIT command is received from the customer or the task times out, the task terminates, and the step S150 is then performed. If no QUIT command is received from the customer or the task does not time out, the step S130 is then performed. As mentioned above, it is necessary to terminate a task compulsorily under some special condition, so as to meet customers' needs and prevent a recipe task from occupying processing resources for a long time. In some embodiments, the customers may be given an option of exiting a task voluntarily, considering that it is likely that the customers (especially the middle aged and elderly people) have to quit the tasks due to the accidents (such as physical discomfort, accidental injuries, physical exhaustion, or other emergencies that need to be dealt with) that occur while looking for the promotional commodities and the relevant commodities, or the customers may not be interested in continuing with the promotional activity. When the customers choose such option, the recipe tasks may terminate compulsorily, thereby satisfying the special needs of the customer, and improving customer experience. In other embodiments, maximum completion time for a recipe task may be preset. If the maximum completion time is exceeded, the task will be regarded as timeout, and the recipe task terminates compulsorily, thereby increasing utilization of processing resources.

Accordingly, a fact whether the recipe task is completed is determined at the step S140, and if it is determined that the recipe task is completed, the step S150 is then performed to generate preferential information, which is similar to the embodiment in FIG. 1; if it is determined that the task is not completed, the step S130′ is then performed to continue to determine whether a QUIT command is received or whether the task times out, alternatively the step S130 is directly performed to continue to receive the commodity information from the customer, at this time the customer may be prompted that “the task has not been completed, please continue”.

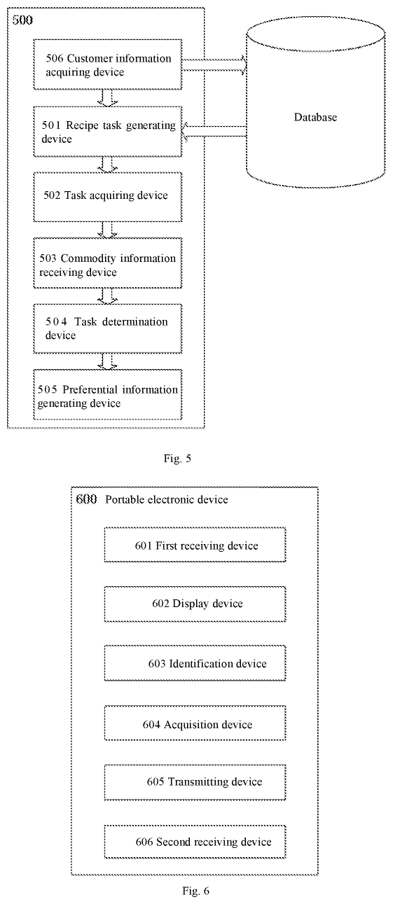

FIG. 5 shows a computing apparatus for generating preferential information according to a recipe task according to the embodiments of the present disclosure. As described above, the method for generating preferential information according to a recipe task according to the embodiments of the present disclosure may be performed by the computing apparatus for generating preferential information shown in FIG. 5. As shown in FIG. 5, a computing apparatus 500 for generating preferential information according to a recipe task includes: a recipe task generating device 501, a task acquiring device 502, a commodity information receiving device 503, a task determination device 504, and a preferential information generating device 505.

The recipe task generating device 501 is configured to generate a recipe task associated with at least one commodity.

The task acquiring device 502 is configured to acquire a selection of the recipe task from a customer.

The commodity information receiving device 503 is configured to receive from the customer commodity information of a commodity found by the customer according to the recipe task.

The task determination device 504 is configured to compare the received commodity information with the at least one commodity, and determine that the recipe task is finished in response to the received commodity information matches the at least one commodity.

The preferential information generating device 505 is configured to generate preferential information after it is determined that the recipe task is finished.

As shown in FIG. 5, according to the embodiments, the computing apparatus 500 for generating preferential information may further include a customer information acquiring device 506 configured to acquire customer information to build a membership database. The recipe task generating device 501 is further configured to generate the recipe task according to membership information in the membership database.

As shown in FIG. 5, in the computing apparatus for generating preferential information according to the embodiments of the present disclosure, the recipe task generating device 501 may generate a recipe task based on a commodity database, the membership database, and a recipe database, and the commodity database, the membership database and the recipe database may be stored locally, that is, being stored in a memory of the computing apparatus, so as to be easily called by other modules.

Alternatively, those databases may be stored in a computer data management system or a server in the store, and the computing apparatus for generating preferential information may call those databases from the system or server via a wired or wireless network when needed. Optionally, those databases may also be stored in the Cloud (or on the Internet), so that the computing apparatus can call those databases in real time via the Internet.

Alternatively, as described above, the method for generating preferential information according to a recipe task according to the present disclosure may also be performed by the computing apparatus shown in FIG. 5 together with a mobile terminal or a portable electronic device such as a mobile phone.

FIG. 6 shows a portable electronic device 600 configured to communicate with the computing apparatus shown in FIG. 5, according to the embodiments of the present disclosure. The portable electronic device 600 includes: a first receiving device 601, a display device 602, an identification device 603, an acquisition device 604, a transmitting device 605, and a second receiving device 606.

The first receiving device 601 is configured to receive a recipe task from the computing apparatus.

The display device 602 is configured to display the recipe task.

The identification device 603 is configured to identify a selection of the recipe task from a customer.

The acquisition device 604 is configured to acquire commodity information of a commodity found by a customer according to the recipe task.

The transmitting device 605 is configured to transmit the identified selection and the acquired commodity information to the computing apparatus.

The second receiving device 606 is configured to receive a determination result of the recipe task and preferential information from the computing apparatus.

For example, the portable electronic device 600 operates as follows:

Firstly, the portable electronic device 600 may receive a recipe task from the computing apparatus for generating preferential information with the first receiving device 601 via, for example, a wired or wireless network (e.g. WIFI and Bluetooth); alternatively, the user may obtain the recipe task by scanning a QR code of the recipe task generated by the computing apparatus. The customer can scan the QR code with a mobile phone, the recipe task or a web link to the recipe task may be generated according to the QR code, and the customer can obtain the recipe task by accessing the web link.

Then, the portable electronic device 600 may display the recipe task to the customer on the display device 602. The display device 602 may include a display and a speaker for displaying the recipe task by image or sound.

And then, the portable electronic device 600 may receive the customer's selection of the recipe task through the identification device 603. The identification device 603 may include, for example, an input device such as a keyboard, a mouse and a touch screen, which are used for the selection of the recipe task.

Then, after the customer has found an interesting recipe task, the acquisition device 604 of the portable electronic device 600 acquires the commodity information of the found commodity by taking a picture or scanning a QR code (e.g. a camera or a scanning device); in addition, the customer may acquire the above-mentioned control command (such as a QUIT command) by using other acquisition devices (e.g. an input device).

Then, the transmitting device 605 of the portable electronic device 600 may transmit the identified selection of the recipe task and the acquired commodity information to the computing apparatus via a network.

Finally, the second receiving device 606 of the portable electronic device 600 may receive the determination result concerning whether the recipe task is completed and the generated preferential information.

Furthermore, the portable electronic device 600 may download from the computing apparatus 500 an applet or app that is created by the computing apparatus 500 to perform all the steps of the above method for generating preferential information according to a recipe task. In this way, the customer can generate preferential information only by using the portable electronic device 600 and the applet installed thereon. In addition, after the customer completes the task, the app or applet binds the commodities in the recipe task together and directly generates a payment identification code or a coupon according to a discount.

The embodiments of the present disclosure further provide a system for generating preferential information, including a computing apparatus for generating preferential information according to some embodiments of the present disclosure, and the portable electronic device according to some embodiments of the present disclosure.

The present disclosure further relates to one or more computer storage media having a computer program stored thereon. When the computer program is executed on a processor, the above method for generating preferential information according to a recipe task according to some embodiments of the present disclosure is performed.

An embodiment of the present disclosure further provides another system for generating preferential information. The system includes: a recipe task generating device, a display device, an identification device, an acquisition device, a task determination device, and a preferential information generating device.

The recipe task generating device is configured to generate a recipe task associated with at least one commodity.

The display device is configured to display the recipe task.

The identification device is configured to identify customer's selection of the recipe task.

The acquisition device is configured to acquire commodity information of a commodity found by a customer according to the recipe task.

The task determination device is configured to compare the received commodity information with the at least one commodity, and determine that the recipe task is finished in response to the received commodity information matches the at least one commodity.

The preferential information generating device is configured to generate preferential information after it is determined that the recipe task is finished.

The above system may be implemented separately on a mobile terminal (such as a mobile phone), for example, a method for generating preferential information according to a recipe task may be realized by using an applet or app that is downloaded from the computing apparatus for generating preferential information and includes the above program modules or devices.

The logic and/or steps shown in the flowcharts or described herein in other ways may, for example, be considered as an ordered list of executable instructions for performing logical functions, and be practically implemented in any computer-readable medium so as to be used by an instruction execution system, device or apparatus (such as a computer-based system, a system including a processor, or other system that can read the instructions from the instruction execution system, device or apparatus and execute the instructions), or to be used together with the instruction execution system, device or apparatus. In the Description of the present disclosure, the “computer-readable medium” may be any device that can contain, store, communicate, broadcast, or transmit programs for the instruction execution system, device or apparatus to use or to be used together with the instruction execution system, device or apparatus. Specific examples of the computer-readable medium may include any of the following: an electrical connector (electronic device) having with one or more wires, a portable computer cartridge (magnetic device), a Random Access Memory, a Read Only Memory, an Erasable Programmable Read Only Memory or a flash memory, an optical fiber device, and a portable Compact Disc Read Only Memory. Further, the computer-readable medium may even be paper or other suitable medium on which a program can be printed, in this case the program can be obtained by electronic means, for example, by optically scanning the paper or other medium and processing such as compiling, interpreting or in other suitable manners if necessary, and then the program is stored in a memory of the computer.

It should be understood that all the parts disclosed in the present disclosure may be implemented by hardware, software, firmware, or combinations thereof. In the above embodiments, the plurality of steps or methods may be implemented by the software or firmware that is stored in a memory and executed by a suitable instruction execution system. For example, if implemented by hardware, the plurality of steps or methods may be implemented by any one or a combination of the following technologies that are well known in the art: a discrete logic circuit having a logic gate circuit configured to perform logic functions to data signals, an application specific integrated circuit having a suitable combinational logic gate circuit, a Programmable Gate Array, and a Field Programmable Gate Array.

It should be understood that the above embodiments are merely exemplary embodiments employed to illustrate the principles of the present disclosure, and the present disclosure is not limited thereto. Various changes and modifications can be made without departing from the spirit and essence of the present disclosure, and should be considered to fall within the scope of the present disclosure.

1. A method for generating preferential information according to a recipe task, comprising:
a recipe task generation step of generating, by a recipe task generating device, a recipe task associated with at least one commodity;
a task acquisition step of acquiring, by a task acquiring device, a selection of the recipe task from a customer;
a commodity information receiving step of receiving, by a commodity information receiving device, from the customer commodity information of a commodity found by the customer according to the recipe task;
a task determination step of comparing, by a task determination device, the received commodity information with the at least one commodity, and determining that the recipe task is finished in response to the received commodity information matches the at least one commodity; and
a preferential information generation step of generating, by a preferential information generating device, preferential information associated with the at least one commodity after the recipe task is finished.

2. The method of claim 1, wherein the at least one commodity is a promotional commodity comprising at least one of an unsalable commodity, a commodity with a short shelf life and a promoted commodity.

3. The method of claim 2, wherein the at least one commodity further comprises a relevant commodity associated with the promotional commodity and includes at least one of an ingredient, a seasoning, and a tool for preparing a dish in the recipe task.

4. The method of claim 1, wherein the commodity information comprises at least one of a picture and a barcode of a commodity.

5. The method of claim 1, wherein the preferential information comprises at least one of an electronic coupon and a physical coupon.

6. The method of claim 1, wherein a preferential degree of the preferential information is inversely proportional to time spent by the customer in completing the recipe task.

7. The method of claim 1, wherein the preferential information generation step further comprises: pushing a cooking video of the dish in the recipe task to the customer.

8. The method of claim 2, wherein the recipe task generation step further comprises: generating a plurality of candidate recipe tasks according to a promotion priority of the promotional commodity, a number of the promotional commodity, or a production date of the promotional commodity.

9. The method of claim 8, wherein the task acquisition step comprises: acquiring a selection, from the customer, of a recipe task for at least one of the plurality of candidate recipes.

10. The method of claim 1, further comprising: a step of acquiring, by a customer information acquiring device, customer information before the recipe task generation step, and
the recipe task generation step comprises generating the recipe task based on the customer information.

11. The method of claim 10, wherein the step of acquiring the customer information comprises:
receiving ID information from the customer;
matching the ID information of the customer with membership ID information in a membership database to determine whether the customer is a member; and
serving membership information of the customer as the customer information in response to that the customer is a member; otherwise, determining the non-member customer as a new member and acquiring the membership information input by the new member, and serving the acquired membership information as the customer information.

12. The method of claim 1, between the task acquisition step and the commodity information receiving step, further comprising:
determining whether a QUIT command input by the customer is received or whether the recipe task times out; and
performing the preferential information generation step in response to the QUIT command is received or the recipe task times out.

13. The method of claim 2, wherein the recipe task generation step further comprises: retrieving information associated with the promotional commodity from a database through big data analysis.

14. A computing apparatus for generating preferential information according to a recipe task, comprising:
a recipe task generating device configured to generate a recipe task associated with at least one commodity;
a task acquiring device configured to acquire a selection of the recipe task from a customer;
a commodity information receiving device configured to receive from the customer commodity information of a commodity found by the customer according to the recipe task;
a task determination device configured to compare the received commodity information with the at least one commodity, and determine that the recipe task is finished in response to the received commodity information matches the at least one commodity; and
a preferential information generating device configured to generate preferential information associated with the at least one commodity after the recipe task is finished.

15. The computing apparatus of claim 14, further comprising:
a customer information acquiring device configured to acquire customer information; wherein
the recipe task generating device is further configured to generate the recipe task based on the customer information.

16. A computer storage medium having a computer program stored thereon, wherein, when the computer program is executed on a processor, the following steps are performed:
generating a recipe task associated with at least one commodity;
acquiring a selection of the recipe task from a customer;
receiving from the customer commodity information of a commodity found by the customer according to the recipe task;
comparing the received commodity information with the at least one commodity, and determining that the recipe task is finished in response to the received commodity information matches the at least one commodity; and
generating preferential information associated with the at least one commodity after the recipe task is finished.

17-19. (canceled)
